(19) United States
(12) Patent Application Publication
(10) Pub. No.: US 2020/0389049 A1
(43) Pub. Date: Dec. 10, 2020

(54) ELECTRIC POWER CONTROL APPARATUS AND DRIVE UNIT

(71) Applicant: HONDA MOTOR CO., LTD., Tokyo (JP)

(72) Inventor: Hiroshi Kunii, Wako-shi (JP)

(21) Appl. No.: 16/884,084

(22) Filed: May 27, 2020

(30) Foreign Application Priority Data
Jun. 7, 2019 (JP) 2019-106820

(51) Int. Cl. H02J 50/00; H01F 30/04; H01F 30/06; H01F 27/16; H01F 37/00; H01F 27/38; H02J 50/10; H02J 50/70

(52) U.S. Cl. CPC H02J 50/005; H01F 30/04; H01F 30/06; H02J 50/70; H01F 37/00; H01F 27/38; H02J 50/10; H01F 27/16

(57) ABSTRACT

An electric power control apparatus includes a controller that controls transfer of electric power between a motor and a power storage device; and a case that accommodates the controller. The controller includes a magnetically coupled reactor. At least part of the case around the reactor includes a non-conductive wall portion formed of a non-conductive material.

### CROSS-REFERENCE TO RELATED APPLICATION

Priority is claimed on Japanese Patent Application No. 2019-106820, filed on Jun. 7, 2019, the contents of which are incorporated herein by reference.

### BACKGROUND

### Field of the Invention

The present invention relates to an electric power control apparatus and a drive unit.

### Background

In the related art, an electric power conversion device including a semiconductor element, a capacitor, and a reactor which are embedded inside a case using a resin in order to improve vibration-damping properties is known (for example, refer to Japanese Unexamined Patent Application, First Publication No. 2009-232564).

In addition, in the related art, a converter (electric power conversion device) using a reactor including a magnetically coupled coil is known (for example, Japanese Unexamined Patent Application, First Publication No. 2014-127637).

### SUMMARY

For example, a magnetically coupled reactor provided in a booster circuit or the like performs boosting operation by actively utilizing an inductance caused by a leakage magnetic flux which is generated in a three-dimensional manner.

In an electric power conversion device, conventionally, electromagnetic shielding is performed using a conductive member (an aluminum case or the like) which is disposed to block a high-frequency magnetic field. For this reason, when a leakage magnetic flux of a reactor is blocked using a case, other internal components, or the like, the leakage magnetic flux is converted into heat due to an eddy current generated in a conductive member when the leakage magnetic flux passes through the conductive member. Therefore, there is a possibility that a desired leakage inductance may not be able to be secured and there will be a need to increase the physical size of the reactor.

An object of an aspect of the present invention is to provide an electric power control apparatus and a drive unit capable of securing an inductance required for desired boosting operation.

According to a first aspect of the present invention, an electric power control apparatus is provided including a controller that controls transfer of electric power between a motor and a power storage device; and a case that accommodates the controller. The controller includes a magnetically coupled reactor. At least part of the case around the reactor includes a non-conductive wall portion formed of a non-conductive material.

According to a second aspect of the present invention, the electric power control apparatus according to the first aspect may further include a cooler that cools the reactor. A surface of the case around the reactor overlapping the cooler in a plan view may be formed of a non-conductive material.

According to a third aspect of the present invention, in the electric power control apparatus according to the first or second aspect, a side surface of the case around the reactor may be formed of a non-conductive material.

According to a fourth aspect of the present invention, in the electric power control apparatus according to any one of the first to third aspects, a lower part of the case may be formed of a non-conductive material.

According to a fifth aspect of the present invention, a drive unit is provided including the electric power control apparatus according to any one of the first to fourth aspects; and a second case that accommodates the motor and is connected to the case. The non-conductive wall portion is provided in part of the case on the second case side.

According to a sixth aspect of the present invention, in the drive unit according to the fifth aspect, the second case may be disposed away from the non-conductive wall portion by a predetermined interval.

According to the first aspect, since a leakage magnetic flux around the magnetically coupled reactor is used for boosting operation, inflow of a magnetic flux to the case can be curbed by providing the non-conductive wall portion in at least part of the case. Accordingly, incidents in which a desired leakage magnetic flux around the reactor is blocked and is converted into heat can be curbed, and an inductance which is caused by a leakage magnetic flux and is required for desired boosting operation can be secured.

In the case of the second aspect, the surface of the case overlapping the cooler in a plan view is formed of a non-conductive material. Therefore, a space and an interval required for distribution of desired leakage magnetic fluxes can be secured between the reactor and the non-conductive material.

In the case of the third aspect, the side surface of the case is formed of a non-conductive material. Therefore, a desired leakage inductance can be secured more effectively.

In the case of the fourth aspect, the lower part of the case is formed of a non-conductive material. Therefore, a desired leakage inductance can be secured more effectively.

In the case of the fifth aspect, the non-conductive wall portion is provided in part of the case on the second case side. Therefore, a magnetic flux passing through the non-conductive wall portion can be blocked by the second case. Accordingly, for example, increase in radiation noise can be curbed while increase in size of the case is curbed, and enlargement of the configuration can be curbed.

In the case of the sixth aspect, the second case blocking a magnetic flux from the reactor is disposed away from the non-conductive wall portion by a predetermined interval. Therefore, while incidents in which a desired leakage magnetic flux around the reactor used for boosting operation is blocked and is converted into heat are curbed, increase in radiation noise due to an unnecessary magnetic flux can be curbed.

### BRIEF DESCRIPTION OF THE DRAWINGS

FIG. 1 is an exploded perspective view schematically illustrating a configuration of a drive unit according to an embodiment of the present invention.

FIG. 2 is a cross-sectional view illustrating the configuration of the drive unit according to the embodiment of the present invention.

FIG. 3 is a view of the configuration of the drive unit according to the embodiment of the present invention.

FIG. 4 is a plan view illustrating a configuration of a magnetically coupled reactor of a voltage conversion device according to the embodiment of the present invention.

FIG. 5 is a perspective view schematically illustrating the configuration of the magnetically coupled reactor of the voltage conversion device according to the embodiment of the present invention.

FIG. 6 is a cross-sectional view illustrating a configuration of a drive unit according to a modification example of the embodiment of the present invention.

FIG. 7 is a side view illustrating the configuration of the drive unit according to the modification example of the embodiment of the present invention.

FIG. 8 is a plan view illustrating a configuration of a magnetically coupled reactor of a voltage conversion device according to the modification example of the embodiment of the present invention.

FIG. 9 is an exploded perspective view schematically illustrating the configuration of the magnetically coupled reactor of the voltage conversion device according to the modification example of the embodiment of the present invention.

FIG. 10 is a view schematically illustrating a magnetic flux in the magnetically coupled reactor of the voltage conversion device according to the modification example of the embodiment of the present invention.

### DESCRIPTION OF EMBODIMENTS

Hereinafter, an embodiment of a drive unit and an electric power control apparatus according to the present invention will be described with reference to the accompanying drawings.

For example, a drive unit 1 according to the present embodiment is mounted in a vehicle such as an electrically driven vehicle or the like. An electrically driven vehicle is an electric car, a hybrid vehicle, a fuel battery vehicle or the like. An electric car is driven using a battery as a power source. A hybrid vehicle is driven using a battery and an internal-combustion engine as a power source. A fuel battery vehicle is driven using a fuel battery as a power source.

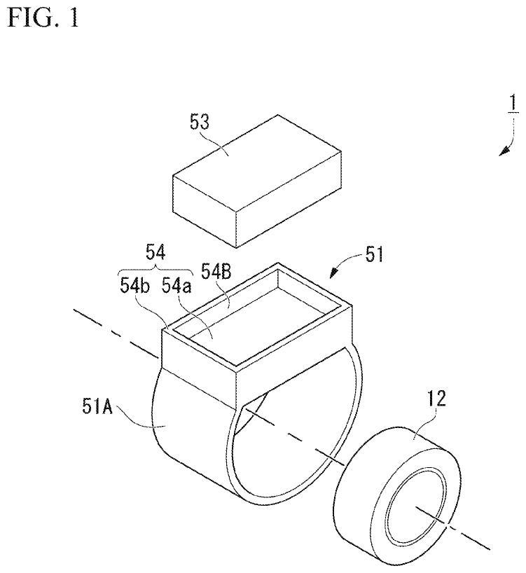

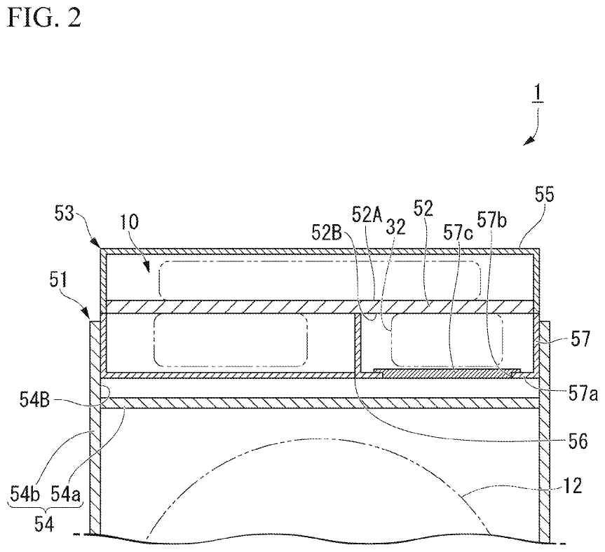

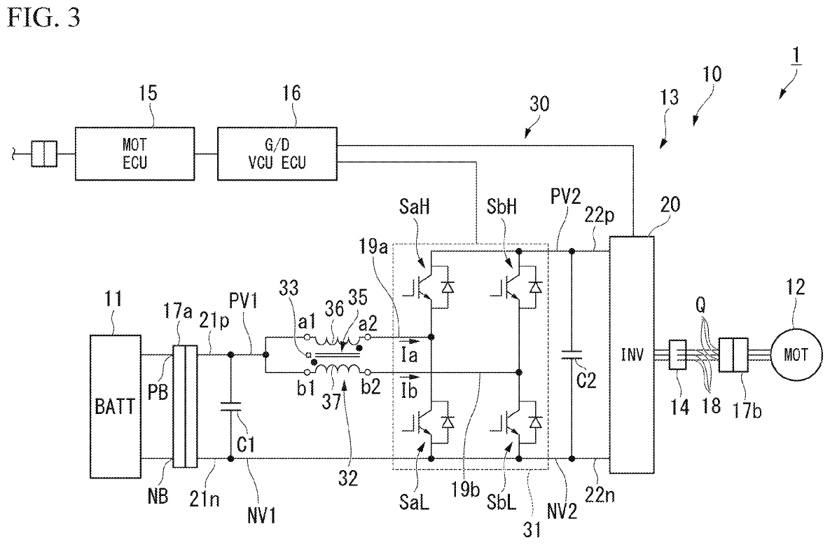

FIG. 1 is an exploded perspective view schematically illustrating a configuration of the drive unit 1 according to the embodiment. FIG. 2 is a cross-sectional view illustrating the configuration of the drive unit 1 according to the embodiment. FIG. 3 is a view of the configuration of the drive unit 1 according to the embodiment.

<Drive Unit>

As illustrated in FIG. 3, the drive unit 1 includes an electric power control apparatus 10, a battery 11 (BATT) (power storage device), and a motor 12 (MOT) for traveling driving.

The electric power control apparatus 10 includes a power module 13 (control unit), a first smoothing capacitor C1, a second smoothing capacitor C2, a current sensor 14, an electronic control unit 15 (MOT ECU) (control unit), and a gate drive unit 16 (G/D VCU ECU) (control unit).

For example, the battery 11 is a high-voltage battery serving as a power source for a vehicle. The battery 11 includes a battery case and a plurality of battery modules which are accommodated inside the battery case. The battery modules include a plurality of battery cells connected in series or in parallel.

The battery 11 includes a positive electrode terminal PB and a negative electrode terminal NB connected to a DC connector 17a. The positive electrode terminal PB and the negative electrode terminal NB are connected to positive electrode ends and negative electrode ends of the plurality of battery modules connected in series or in parallel inside the battery case.

The motor 12 generates a rotary driving force (power running operation) using power supplied from the battery 11. The motor 12 may generate generation power using a rotary driving force input to a rotary shaft. The motor 12 may be constituted such that rotary power of an internal-combustion engine can be transmitted. For example, the motor 12 is a three-phase AC brushless DC motor. Three phases are constituted of a U phase, a V phase, and a W phase.

The motor 12 includes a rotor which has a permanent magnet for a magnetic field and a stator which has three-phase stator windings for generating a rotating magnetic field for rotating the rotor. The three-phase stator windings of the motor 12 are connected to a three-phase connector 17b.

For example, the power module 13 includes an inverter (INV) 20 which performs power conversion between a DC and a three-phase AC, and a bridge circuit 31 of a voltage conversion device 30 (control unit) which will be described below.

The inverter 20 includes a bridge circuit constituted of a plurality of switching elements in bridge-connection. For example, the switching elements are transistors such as insulated gate bipolar transistors (IGBTs) or metal oxide semi-conductor field effect transistors (MOSFETs). For example, in the bridge circuit, in each of the three phases including the U phase, the V phase, and the W phase, the transistors of high-side arms and low-side arms constituting pairs are in bridge-connection. The bridge circuit includes diodes which are connected to be in a forward direction from emitters to collectors between the collectors and the emitters of the respective transistors.

In the transistor of each phase of the high-side arm, the collector is connected to a positive electrode bus bar, thereby constituting the high-side arm. The positive electrode bus bar of each phase of the high-side arm is connected to a second positive electrode bus bar 22p of the second smoothing capacitor C2 (which will be described below).

In the transistor of each phase of the low-side arm, the emitter is connected to a negative electrode bus bar, thereby constituting the low-side arm. The negative electrode bus bar of each phase of the low-side arm is connected to a second negative electrode bus bar 22n of the second smoothing capacitor C2 (which will be described below).

In each phase of the high-side arms and the low-side arms, the emitter of the transistor of the high-side arm and the collector of the transistor of the low-side arms are connected to each other via an input/output bus bar 18. The input/output bus bar 18 of each phase is connected to an input/output terminal Q, and the input/output terminal Q of each phase is connected to the three-phase connector 17b. The input/output bus bar 18 of each phase is connected to the stator winding of each phase of the motor 12 via the input/output terminal Q and the three-phase connector 17b.

The inverter 20 switches between ON (conducting state)/OFF (blocked state) of the transistor pairs of each phase on the basis of a gate signal which is a switching command input to a gate of each transistor from the gate drive unit 16. The inverter 20 electrifies the three-phase stator windings with an AC U phase current, an AC V phase current, and an AC W phase current by converting DC power input from the battery 11 via the voltage conversion device 30 into three-phase AC power and sequentially commutating electrification to the three-phase stator windings of the motor 12.

The inverter 20 may convert three-phase AC power output from the three-phase stator windings of the motor 12 into DC power through ON (conducting state)/OFF (blocked state) driving of the transistor pairs of each phase synchronized with rotation of the motor 12. DC power converted from three-phase AC power by the inverter 20 can be supplied to the battery 11 via the voltage conversion device 30.

For example, the first smoothing capacitor C1 and the second smoothing capacitor C2 constitute a capacitor unit. For example, the capacitor unit may include a noise filter or the like constituted of two capacitors, in addition to the first and second smoothing capacitors C1 and C2.

The first smoothing capacitor C1 is connected to a part between a first positive electrode bus bar 21p connected to a positive electrode terminal of the DC connector 17a and a first negative electrode bus bar 21n connected to a negative electrode terminal of the DC connector 17a. For example, the first smoothing capacitor C1 smooths a voltage fluctuation occurring in accordance with an ON/OFF switching operation of each of transistors SaH, SaL, SbH, and SbL at the time of stepping-down of the voltage conversion device 30.

The second smoothing capacitor C2 is connected to a part between the second positive electrode bus bar 22p connected to the positive electrode bus bar of the inverter 20 and a second positive electrode bus bar PV2 (which will be described below) of the voltage conversion device 30 and the second negative electrode bus bar 22n connected to the negative electrode bus bar of the inverter 20 and a second negative electrode bus bar NV2 (which will be described below) of the voltage conversion device 30. The second smoothing capacitor C2 smooths a voltage fluctuation occurring in accordance with an ON/OFF switching operation of each of the transistor pairs in the inverter 20 and a voltage fluctuation occurring in accordance with an ON/OFF switching operation of each of the transistors SaH, SaL, SbH, and SbL at the time of boosting of the voltage conversion device 30.

For example, the current sensor 14 is disposed in the input/output bus bars 18 of each phase and detects a current of each of the U phase, the V phase, and the W phase. The current sensor 14 is connected to the electronic control unit 15 through a signal line. The electronic control unit 15 controls operation of the motor 12. For example, the electronic control unit 15 is a software functioning unit which functions when a predetermined program is executed by a processor such as a central processing unit (CPU). The software functioning unit is an electronic control unit (ECU) including an electronic circuit having a processor such as a CPU, a read only memory (ROM) storing a program, a random access memory (RAM) temporarily storing data, a timer, and the like. At least part of the electronic control unit 15 may be an integrated circuit such as a large scale integration (LSI).

For example, the electronic control unit 15 executes feedback control or the like of a current using a current detection value of the current sensor 14 and a current target value according to a torque command value with respect to the motor 12 and generates a control signal to be input to the gate drive unit 16. A control signal is a signal indicating a timing for ON (conducting state)/OFF (blocked state) driving of each of the transistor pairs of the power module 13. For example, a control signal is a signal or the like subjected to pulse width modulation.

The gate drive unit 16 generates a gate signal for actually performing ON (conducting state)/OFF (blocked state) driving of each of the transistor pairs of the inverter 20 on the basis of a control signal received from the electronic control unit 15. For example, the gate drive unit 16 generates a gate signal by executing amplification, level-shifting, or the like of a control signal.

The gate drive unit 16 generates a gate signal for ON (conducting state)/OFF (blocked state) driving of each of the transistors SaH, SaL, SbH, and SbL of the voltage conversion device 30. For example, the gate drive unit 16 generates a gate signal at a duty ratio corresponding to a boosting voltage command at the time of boosting of the voltage conversion device 30 or a step-down voltage command at the time of stepping-down of the voltage conversion device 30. For example, a duty ratio is a ratio of an ON time of each of the transistors SaH and SaL and a ratio of an ON time of each of the transistors SbH and SbL.

<Voltage Conversion Device>

The electric power control apparatus 10 includes the voltage conversion device 30. For example, the voltage conversion device 30 includes the bridge circuit 31 and a magnetically coupled reactor 32; and the electronic control unit 15 and the gate drive unit 16 which have been described above.

For example, the bridge circuit 31 includes four switching elements in bridge-connection in two phases constituted of an A phase and a B phase. For example, the switching elements are transistors such as MOSFETs. In the bridge circuit 31, the A phase transistors SaH and SaL of the high-side arm and the low-side arm constituting a pair in the A phase and the B phase transistors SbH and SbL of the high-side arm and the low-side arm constituting a pair in the B phase are in bridge-connection, respectively.

The collector of the high-side arm A phase transistor SaH and the collector of the high-side arm B phase transistor SbH are connected to the second positive electrode bus bar PV2, thereby constituting the high-side arms. The emitter of the low-side arm A phase transistor SaL and the emitter of the low-side arm B phase transistor SbL are connected to the second negative electrode bus bar NV2, thereby constituting the low-side arms. The emitter of the high-side arm A phase transistor SaH is connected to the collector of the low-side arm A phase transistor SaL. The emitter of the high-side arm B phase transistor SbH is connected to the collector of the low-side arm B phase transistor SbL. The bridge circuit 31 includes diodes which are connected to be in the forward direction from the emitters toward the collectors between the collectors and the emitters of the respective transistors SaH, SaL, SbH, and SbL.

The emitter of the high-side arm A phase transistor SaH and the collector of the low-side arm A phase transistor SaL are connected to each other via an A phase input/output bus bar 19a. The A phase input/output bus bar 19a is connected to a second end portion a2 of an A phase coil 36 (which will be described below) of the magnetically coupled reactor 32.

The emitter of the high-side arm B phase transistor SbH and the collector of the low-side arm B phase transistor SbL are connected to each other via a B phase input/output bus bar 19b. The B phase input/output bus bar 19b is connected to a second end portion b2 of a B phase coil 37 (which will be described below) of the magnetically coupled reactor 32.

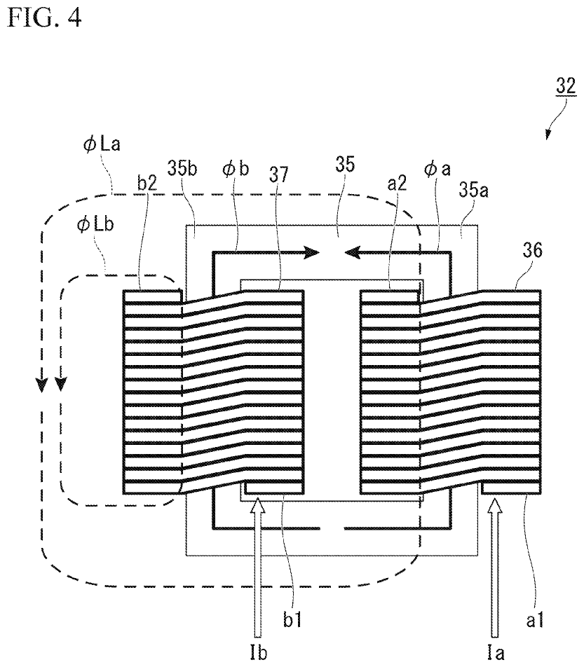

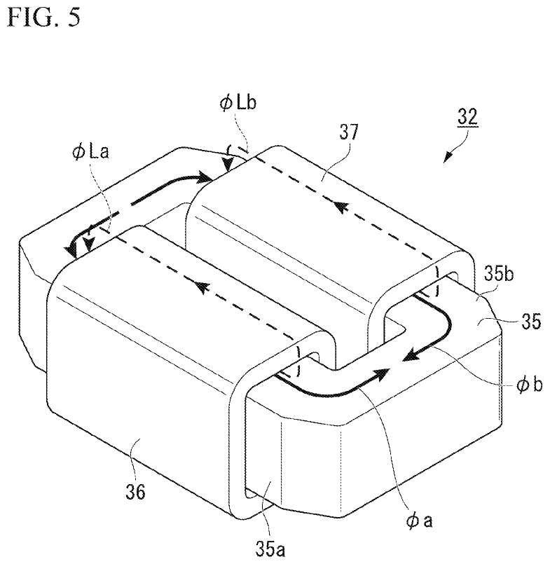

FIG. 4 is a plan view illustrating a configuration of the magnetically coupled reactor 32 of the voltage conversion device 30 according to the embodiment. FIG. 5 is a perspective view schematically illustrating the configuration of the magnetically coupled reactor 32 of the voltage conversion device 30 according to the embodiment.

As illustrated in FIGS. 4 and 5, the magnetically coupled reactor 32 includes a core 35, the A phase coil 36, and the B phase coil 37.

For example, the core 35 is formed to have a rectangular ring shape as the external shape thereof. For example, the core 35 is constituted of a laminate or the like of dust cores or electromagnetic steel sheets.

For example, the A phase coil 36 and the B phase coil 37 are edgewise coils or the like realized by edgewise-winding rectangular wire conductors having the same shape. A first end portion a1 of the A phase coil 36 is connected to a first positive electrode bus bar PV1. The second end portion a2 of the A phase coil 36 is connected to the A phase input/output bus bar 19a. A first end portion b1 of the B phase coil 37 is connected to the first positive electrode bus bar PV1. The second end portion b2 of the B phase coil 37 is connected to the B phase input/output bus bar 19b.

Each of the A phase coil 36 and the B phase coil 37 is wound around each of a first leg portion 35a and a second leg portion 35b of the core 35 by the same number of windings. The A phase coil 36 is wound around the first leg portion 35a. The B phase coil 37 is wound around the second leg portion 35b.

The A phase coil 36 and the B phase coil 37 are wound around the common core 35 such that they are magnetically coupled to each other with reversed polarities.

The A phase coil 36 and the B phase coil 37 have the same winding directions as each other. For example, each of the coils 36 and 37 is wound clockwise when viewed from each of the first end portions a1 and b1 side toward each of the second end portions a2 and b2 side in an axial direction of a central axis.

The A phase coil 36 and the B phase coil 37 are constituted such that directions of magnetic fluxes Φa and Φb generated inside the first leg portion 35a and the second leg portion 35b at the time of electrification are opposite to each other.

For example, the direction of the A phase magnetic flux Φa generated inside the first leg portion 35a during electrification in which a current Ia flows from the first end portion a1 to the second end portion a2 of the A phase coil 36 and the direction of the B phase magnetic flux Φb generated inside the second leg portion 35b during electrification in which a current Ib flows from the first end portion b1 to the second end portion b2 of the B phase coil 37 are opposite to each other.

Since the A phase coil 36 and the B phase coil 37 are magnetically coupled to each other with reversed polarities, when the current Ia flows from the first end portion a1 to the second end portion a2 of the A phase coil 36 due to ON (conducting state) control of the low-side arm A phase transistor SaL, an induced voltage is generated in the B phase coil 37 such that magnetization of the core 35 is offset, and the current Ib flows from the first end portion b1 to the second end portion b2 of the B phase coil 37.

In addition, when the current Ib flows from the first end portion b1 to the second end portion b2 of the B phase coil 37 due to ON (conducting state) control of the low-side arm B phase transistor SbL, an induced voltage is generated in the A phase coil 36 such that magnetization of the core 35 is offset, and the current Ia flows from the first end portion a1 to the second end portion a2 of the A phase coil 36.

At the time of electrification of the A phase coil 36 and the B phase coil 37, an A phase leakage magnetic flux ΦLa due to electrification of the A phase coil 36 and a B phase leakage magnetic flux ΦLb due to electrification of the B phase coil 37 are generated in the surrounding portion outside the core 35. The direction of the A phase leakage magnetic flux ΦLa and the direction of the B phase leakage magnetic flux ΦLb are the same directions as each other.

In the magnetically coupled reactor 32 in which the A phase coil 36 and the B phase coil 37 are magnetically coupled to each other with reversed polarities, for example, a primary side voltage V1 and a secondary side voltage V2 satisfy a relational expression indicated as the following mathematical expression (1). The following mathematical expression (1) indicates a relationship between the primary side voltage V1 and the secondary side voltage V2 using an input current i1, a self-inductance L and a mutual inductance M of each of the A phase coil 36 and the B phase coil 37, and a leakage inductance 1. The leakage inductance 1 is a leakage inductance caused by one of the magnetic fluxes of the A phase coil 36 and the B phase coil 37 which is not interlinked with the other.

$$2 \cdot V 1 - l \frac{di 1}{dt} - ( L - M ) \frac{di 1}{dt} = V 2 \qquad ( 1 )$$

As indicated in the foregoing mathematical expression (1), when a leakage magnetic flux becomes zero, both the second member on the left side and the third member on the left side in the foregoing mathematical expression (1) become zero, and thus voltage conversion cannot be performed. For this reason, an inductance caused by a leakage magnetic flux is required to execute voltage conversion, as indicated in the second member on the left side and the third member on the left side. That is, for example, the magnetically coupled reactor 32 in which the A phase coil 36 and the B phase coil 37 are magnetically coupled to each other with reversed polarities performs voltage conversion using an inductance of a leakage magnetic flux which passes through a space outside the core 35, is generated in one of the A phase coil 36 and the B phase coil 37, and is not interlinked with the other.

The voltage conversion device 30 according to the present embodiment includes a configuration as described above. Next, operation of the voltage conversion device 30 will be described.

The voltage conversion device 30 switches between ON (conducting state)/OFF (blocked state) of the transistor pairs of each phase on the basis of a gate signal which is a switching command input from the gate drive unit 16 to the gate of each of the transistors SaH, SaL, SbH, and SbL.

The voltage conversion device 30 alternately switches at the time of boosting between a first state in which the transistors SaL and SbL of each phase of the low-side arm are set to ON (conducting state) and the transistors SaH and SbH of each phase of the high-side arm are set to OFF (blocked state) and a second state in which the transistors SaL and SbL of each phase of the low-side arm are set to OFF (blocked state) and the transistors SaH and SbH of each phase of the high-side arm are set to ON (conducting state). In the first state, a current flows sequentially to the positive electrode terminal PB of the battery 11, the magnetically coupled reactor 32, the transistors SaL and SbL of each phase of the low-side arm, and the negative electrode terminal NB of the battery 11. Then, the magnetically coupled reactor 32 is subjected to DC excitation, and magnetic energy is accumulated. In the second state, an electromotive voltage (induced voltage) is generated between both ends of the magnetically coupled reactor 32 so as to hinder a change in magnetic flux caused when a current flowing in the magnetically coupled reactor 32 is blocked. An induced voltage caused by magnetic energy accumulated in the magnetically coupled reactor 32 is superimposed on a battery voltage, and a boosting voltage higher than an inter-terminal voltage of the battery 11 is applied to a part between the second positive electrode bus bar PV2 and the second negative electrode bus bar NV2 of the voltage conversion device 30.

The voltage conversion device 30 alternately switches between the second state and the first state at the time of stepping-down. In the second state, a current flows sequentially to the second positive electrode bus bar PV2 of the voltage conversion device 30, the transistors SaH and SbH of each phase of the high-side arm, the magnetically coupled reactor 32, and the positive electrode terminal PB of the battery 11. Then, the magnetically coupled reactor 32 is subjected to DC excitation, and magnetic energy is accumulated. In the first state, an electromotive voltage (induced voltage) is generated between both ends of the magnetically coupled reactor 32 so as to hinder a change in magnetic flux caused when a current flowing in the magnetically coupled reactor 32 is blocked. An induced voltage caused by magnetic energy accumulated in the magnetically coupled reactor 32 is stepped down, and a stepping-down voltage lower than a voltage between the second positive electrode bus bar PV2 and the second negative electrode bus bar NV2 of the voltage conversion device 30 is applied to a part between the positive electrode terminal PB and the negative electrode terminal NB of the battery 11.

The voltage conversion device 30 drives each of the transistors SaH, SaL, SbH, and SbL of the bridge circuit 31 using a so-called two-phase interleave. The voltage conversion device 30 causes one cycle of switching control for each of the A phase transistors SaH and SaL and one cycle of switching control for each of the B phase transistors SbH and SbL to deviate from each other by half a cycle at each time of boosting and stepping-down.

The voltage conversion device 30 executes control for current equalization with respect to the A phase coil 36 and the B phase coil 37 at each time of boosting and stepping-down. The voltage conversion device 30 drives each of the transistors SaH, SaL, SbH, and SbL of the bridge circuit 31 such that the current Ia of the A phase coil 36 and the current Ib of the B phase coil 37 become the same and a current drift rate of the A phase coil 36 and the B phase coil 37 is equalized. For example, the current drift rate is a ratio or the like of the current Ia of the A phase coil 36 or the current Ib of the B phase coil 37 to the sum of the current Ia of the A phase coil 36 and the current Ib of the B phase coil 37.

For example, the electronic control unit 15 controls the duty ratio with respect to switching between ON (conducting state)/OFF (blocked state) of each of the transistors SaH, SaL, SbH, and SbL of the bridge circuit 31 such that the magnitudes of the A phase leakage magnetic flux ΦLa and the B phase leakage magnetic flux ΦLb become the largest.

For example, in the A phase or the B phase, the electronic control unit 15 decreases (or increases) the duty ratio when the magnitude of a detection value output from a magnetic detector (not illustrated) decreases due to the increased (or decreased) duty ratio. For example, the duty ratio of the A phase is the ratio of the ON time of the low-side arm A phase transistor SaL in switching control of each of the A phase transistors SaH and SaL. For example, the duty ratio of the B phase is the ratio of the ON time of the low-side arm B phase transistor SbL in switching control of each of the B phase transistors SbH and SbL.

As illustrated in FIGS. 1 and 2, the drive unit 1 includes a motor housing 51 (second case) which accommodates the motor 12, and a case 53 which accommodates the electric power control apparatus 10 and a cooler 52.

For example, the motor housing 51 is formed to have a bottomed cylindrical shape as the external shape thereof. For example, the motor housing 51 is formed of a metal material such as aluminum. In addition to the motor 12, the motor housing 51 accommodates hydraulic oil or the like serving as a refrigerant.

The motor housing 51 includes a mounting portion 54 in which the case 53 is disposed. For example, the mounting portion 54 is formed to have an open box shape as the external shape thereof. The mounting portion 54 is provided on an outer circumferential surface 51A of the motor housing 51. The mounting portion 54 includes a partitioning portion 54a and a circumferential wall portion 54b surrounding a second accommodation portion 56 (which will be described below) of the case 53.

As the external shape thereof, the partitioning portion 54a is formed to have a plate shape dividing the motor housing 51 into a region in which the motor 12 is accommodated and a region in which the case 53 is disposed.

As the external shape thereof, the circumferential wall portion 54b is formed to have a rectangular tube shape protruding from the outer circumferential surface 51A of the motor housing 51. An inner surface 54B of the circumferential wall portion 54b is connected to a circumferential edge of the partitioning portion 54a.

The cooler 52 is a so-called water jacket. The cooler 52 includes a refrigerant flow channel for circulating a refrigerant, and a refrigerant supply pipe and a refrigerant discharge pipe connected to the refrigerant flow channel. The cooler 52 is provided integrally with some components of the electric power control apparatus 10. For example, some components of the electric power control apparatus 10 include the power module 13, the capacitor unit, the magnetically coupled reactor 32, and the like.

For example, the case 53 is formed to have a box shape as the external shape thereof. For example, the case 53 is formed of a metal material such as aluminum. The case 53 includes a first accommodation portion 55 and the second accommodation portion 56.

The first accommodation portion 55 accommodates various kinds of components disposed on a first mounting surface 52A side of the cooler 52. For example, the first accommodation portion 55 accommodates the power module 13, the electronic control unit 15, the gate drive unit 16, and the like.

The second accommodation portion 56 accommodates various kinds of components disposed on a second mounting surface 52B side of the cooler 52. For example, the second accommodation portion 56 accommodates the capacitor unit, the magnetically coupled reactor 32, and the like.

The second accommodation portion 56 includes a reactor accommodation portion 57 provided to surround the magnetically coupled reactor 32 mounted on the second mounting surface 52B of the cooler 52.

For example, at least part of the reactor accommodation portion 57 is formed of a non-conductive material such as a resin. For example, the reactor accommodation portion 57 includes a non-conductive wall portion 57c which closes a penetration hole 57b formed in a part 57a on the motor housing 51 side. The non-conductive wall portion 57c is provided on a surface (for example, a bottom surface 53a) of the case 53 around the magnetically coupled reactor 32 overlapping the cooler 52 in a plan view.

A distance between the non-conductive wall portion 57c and the partitioning portion 54a of the mounting portion 54 described above is set to a predetermined distance or longer required to secure at least a desired magnetic flux distribution around the magnetically coupled reactor 32. A desired magnetic flux distribution around the magnetically coupled reactor 32 is a distribution of leakage magnetic fluxes (for example, the A phase leakage magnetic flux ΦLa and the B phase leakage magnetic flux ΦLb described above) of the magnetically coupled reactor 32 required for boosting operation of the voltage conversion device 30.

As described above, according to the electric power control apparatus 10 of the present embodiment, a leakage magnetic flux around the magnetically coupled reactor 32 including each of the magnetically coupled coils 36 and 37 is used for boosting operation. At least part of the reactor accommodation portion 57 surrounding the magnetically coupled reactor 32 is formed of a non-conductive material, and thus inflow of a magnetic flux to the reactor accommodation portion 57 can be curbed. Accordingly, incidents in which a desired leakage magnetic flux around the magnetically coupled reactor 32 is blocked and is converted into heat can be curbed, and an inductance which is caused by a leakage magnetic flux and is required for desired boosting operation can be secured.

In addition, the cooler 52 performing heat dissipation of the magnetically coupled reactor 32 is disposed on a side opposite to the motor housing 51 side where the non-conductive wall portion 57c is disposed with respect to the magnetically coupled reactor 32. Accordingly, for example, compared to when the cooler 52 is disposed between the magnetically coupled reactor 32 and the non-conductive wall portion 57c, a space and a gap required for distribution of desired leakage magnetic fluxes can be secured properly between the magnetically coupled reactor 32 and the non-conductive wall portion 57c.

As described above, according to the drive unit 1 of the present embodiment, the non-conductive wall portion 57c is provided in the part 57a of the case 53 on the motor housing 51 side. Therefore, a magnetic flux passing through the non-conductive wall portion 57c can be blocked by the motor housing 51. Accordingly, for example, increase in radiation noise can be curbed while increase in size of the case 53 is curbed, and enlargement of the configuration can be curbed.

In addition, the non-conductive wall portion 57c formed of a non-conductive material such as a resin is provided in part of the second accommodation portion 56 formed of a metal material such as aluminum, for example. Thus, for example, compared to when the second accommodation portion 56 or the case 53 in its entirety is formed of a non-conductive material such as a resin, the rigidity can be improved. Accordingly, for example, a desired rigidity required when various kinds of components are held by the second accommodation portion 56 and when the second accommodation portion 56 is fixed to the motor housing 51 through fastening or the like can be secured easily. While a desired rigidity of the case 53 is secured, incidents in which a leakage magnetic flux is blocked and is converted into heat can be curbed, and a desired leakage inductance can be secured.

In addition, the partitioning portion 54a of the motor housing 51 blocking a magnetic flux of the magnetically coupled reactor 32 is disposed away from the non-conductive wall portion 57c at a predetermined distance or farther. Accordingly, while incidents in which a desired leakage magnetic flux around the magnetically coupled reactor 32 used for boosting operation is blocked and is converted into heat are curbed, increase in radiation noise due to an unnecessary magnetic flux can be curbed.

Hereinafter, a modification example of the embodiment will be described.

In the embodiment described above, the reactor accommodation portion 57 includes the non-conductive wall portion 57c, but the embodiment is not limited thereto. The entirety or part of the reactor accommodation portion 57 may be formed of a non-conductive material such as a resin. In addition, the entirety or part of the case 53 may be formed of a non-conductive material such as a resin. For example, part of the case 53 or part of the reactor accommodation portion 57 is a bottom surface (57a) of the reactor accommodation portion 57 or the bottom surface 53a of the case 53 such as the part 57a on the motor housing 51 side described above, a side surface 57d of the reactor accommodation portion 57 or a side surface 53b of the case 53, and the like.

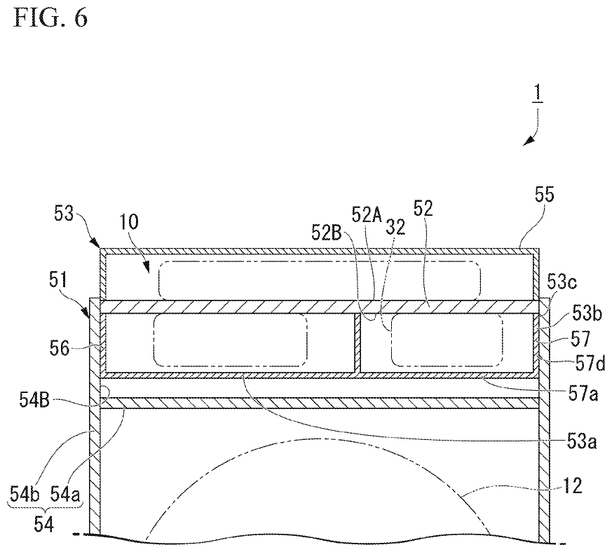

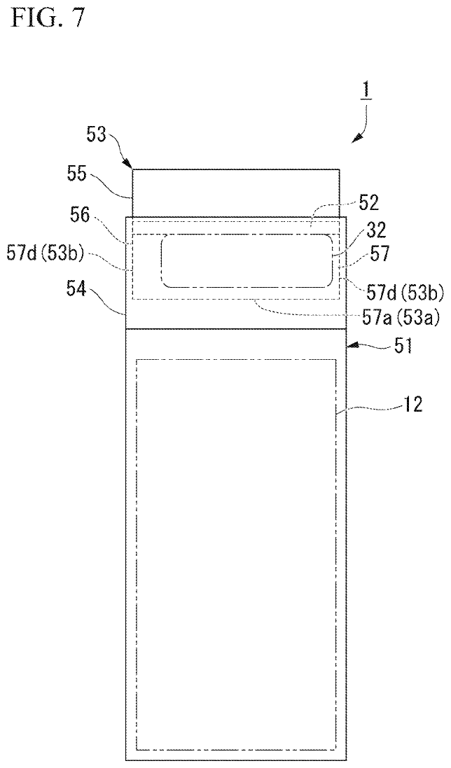

FIG. 6 is a cross-sectional view illustrating a configuration of the drive unit 1 according to the modification example of the embodiment. FIG. 7 is a side view illustrating the configuration of the drive unit 1 according to the modification example of the embodiment. For example, in the modification example illustrated in FIGS. 6 and 7, a lower part 53c of the case 53 is formed of a non-conductive material such as a resin. For example, the lower part 53c of the case 53 includes the bottom surface 53a of the case 53 and a lower part on the side surface 53b of the case 53 (a lower portion of the case 53 in a vertical installation direction and part on the motor housing 51 side). For example, the lower part 53c of the case 53 is the second accommodation portion 56 or the like surrounded by the mounting portion 54 of the motor housing 51.

According to the modification example illustrated in FIGS. 6 and 7, in addition to the bottom surface of the reactor accommodation portion 57 (the part 57a on the motor housing 51 side, that is, a surface on a side opposite to the cooler 52), the side surface 53b surrounding (the front, the rear, the left, the right, and the like) the magnetically coupled reactor 32 is formed of a non-conductive material such as a resin. Accordingly, a desired leakage inductance can be secured more effectively.

In addition, the lower part 53c of the case 53 is surrounded by the mounting portion 54 of the motor housing 51, and thus radiation of electromagnetic noise from the magnetically coupled reactor 32 or other components accommodated inside the second accommodation portion 56 to the outside can be curbed.

In the embodiment described above, the cooler 52 is disposed on a side opposite to the motor housing 51 side with respect to the magnetically coupled reactor 32, but the embodiment is not limited thereto. The cooler 52 may be disposed in a suitable region excluding a part between the magnetically coupled reactor 32 and the non-conductive wall portion 57c.

In the embodiment described above, the magnetically coupled reactor 32 may have a different winding structure.

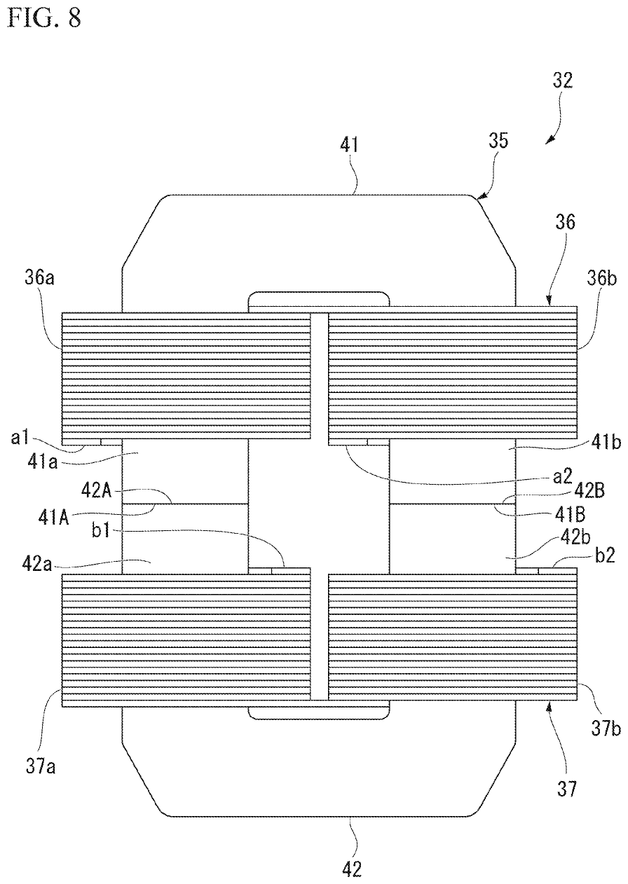

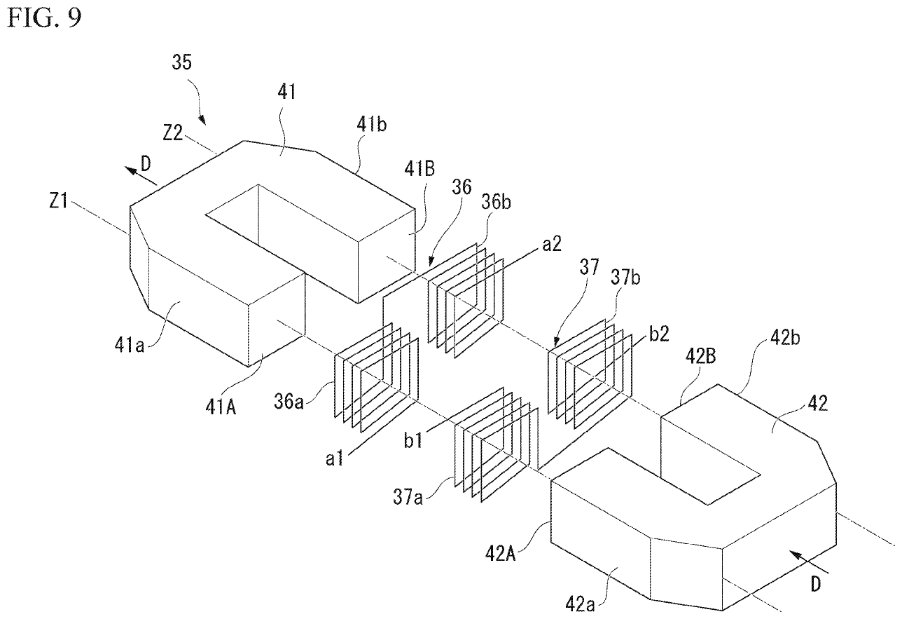

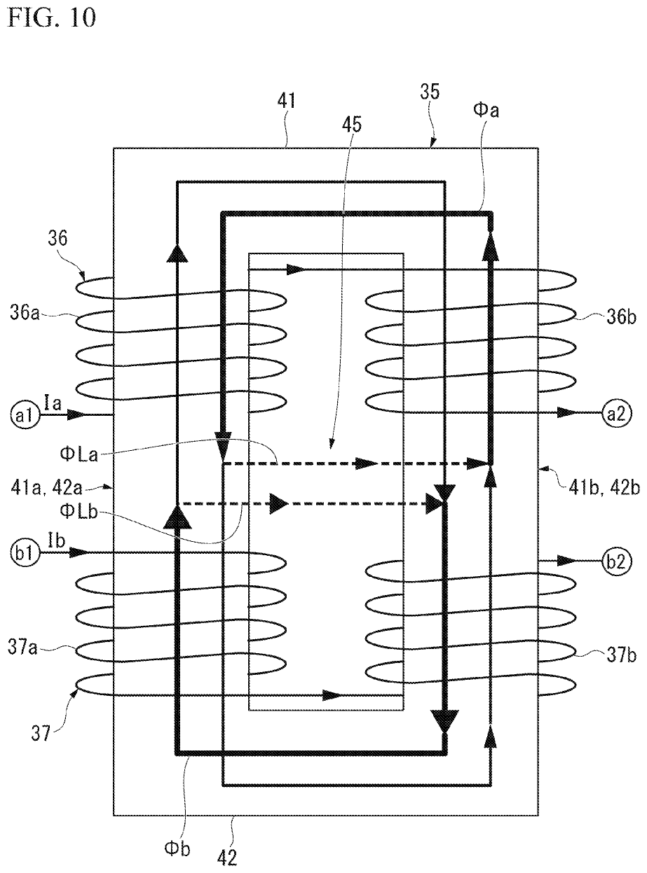

FIG. 8 is a plan view illustrating a configuration of the magnetically coupled reactor 32 of the voltage conversion device 30 according to the modification example of the embodiment. FIG. 9 is an exploded perspective view schematically illustrating the configuration of the magnetically coupled reactor 32 of the voltage conversion device 30 according to the modification example of the embodiment. FIG. 10 is a view schematically illustrating a magnetic flux in the magnetically coupled reactor 32 of the voltage conversion device 30 according to the modification example of the embodiment.

As illustrated in FIGS. 8 and 9, the magnetically coupled reactor 32 of the modification example is a so-called complex reactor including the core 35, the A phase coil 36, and the B phase coil 37.

For example, the core 35 is formed to have a rectangular ring shape as the external shape thereof. For example, the core 35 includes a first split core 41 and a second split core 42. For example, the first split core 41 and the second split core 42 are formed to have the same U-shape as the external shapes thereof. For example, the first split core 41 and the second split core 42 are constituted of a laminate or the like of dust cores or electromagnetic steel sheets.

The first split core 41 and the second split core 42 are disposed such that first end surfaces 41A and 42A of first leg portions 41a and 42a face each other and second end surfaces 41B and 42B of second leg portions 41b and 42b face each other in a first direction (that is, an arrangement direction of the first split core 41 and the second split core 42).

The first split core 41 and the second split core 42 are connected to each other on the first end surfaces 41A and 42A and are connected to each other on the second end surfaces 41B and 42B.

For example, the A phase coil 36 and the B phase coil 37 are edgewise coils or the like realized by edgewise-winding rectangular wire conductors having the same shape. The first end portion a1 of the A phase coil 36 is connected to the first positive electrode bus bar PV1. The second end portion a2 of the A phase coil 36 is connected to the A phase input/output bus bar 19a. The first end portion b1 of the B phase coil 37 is connected to the first positive electrode bus bar PV1. The second end portion b2 of the B phase coil 37 is connected to the B phase input/output bus bar 19b.

Each of the A phase coil 36 and the B phase coil 37 is subjected to split winding around each of the first leg portions 41a and 42a and each of the second leg portions 41b and 42b by the same number of windings. The A phase coil 36 includes a first A phase coil 36a wound around a first leg portion 41a of the first split core 41 and a second A phase coil 36b wound around a second leg portion 41b of the first split core 41. The B phase coil 37 includes a first B phase coil 37a wound around a first leg portion 42a of the second split core 42 and a second B phase coil 37b wound around a second leg portion 42b of the second split core 42. The numbers of windings of the first A phase coil 36a, the second A phase coil 36b, the first B phase coil 37a, and the second B phase coil 37b are the same.

The A phase coil 36 and the B phase coil 37 are wound around the common core 35 such that they are magnetically coupled to each other with reversed polarities.

The central axes of the first A phase coil 36a and the first B phase coil 37a are coaxially provided. The winding directions of the first A phase coil 36a and the first B phase coil 37a are directions opposite to each other. The central axes of the second A phase coil 36b and the second B phase coil 37b are coaxially provided. The winding directions of the second A phase coil 36b and the second B phase coil 37b are directions opposite to each other. In addition, the winding directions of the first A phase coil 36a and the second A phase coil 36b are directions opposite to each other. The winding directions of the first B phase coil 37a and the second B phase coil 37b are directions opposite to each other.

For example, when viewed in an arrangement direction (first direction) D of the first split core 41 and the second split core 42 illustrated in FIG. 9, the first A phase coil 36a is wound counterclockwise from the first end portion a1 which a starting point around a central axis Z1, and the first B phase coil 37a is wound clockwise from the first end portion b1 which is a starting point around the central axis Z1. For example, when viewed in the arrangement direction (first direction) D of the first split core 41 and the second split core 42 illustrated in FIG. 5, the second A phase coil 36b is wound clockwise toward the second end portion a2 which is an ending point around a central axis Z2, and the second B phase coil 37b is wound counterclockwise toward the second end portion b2 which is an ending point around the central axis Z2.

As illustrated in FIG. 10, the A phase coil 36 (that is, the first A phase coil 36a and the second A phase coil 36b) and the B phase coil 37 (that is, the first B phase coil 37a and the second B phase coil 37b) are constituted such that directions of the magnetic fluxes Φa and Φb generated inside the first split core 41 and the second split core 42 at the time of electrification are opposite to each other.

For example, the direction of the A phase magnetic flux Φa generated inside the first split core 41 and the second split core 42 during electrification in which the current Ia flows from the first end portion a1 to the second end portion a2 of the A phase coil 36 and the direction of the B phase magnetic flux Φb generated inside the first split core 41 and the second split core 42 during electrification in which the current Ib flows from the first end portion b1 to the second end portion b2 of the B phase coil 37 are opposite to each other.

Since the A phase coil 36 and the B phase coil 37 are magnetically coupled to each other with reversed polarities, when the current Ia flows from the first end portion a1 to the second end portion a2 of the A phase coil 36 due to ON (conducting state) control of the low-side arm A phase transistor SaL, an induced voltage is generated in the B phase coil 37 such that magnetization of the core 35 is offset, and the current Ib flows from the first end portion b1 to the second end portion b2 of the B phase coil 37.

In addition, when the current Ib flows from the first end portion b1 to the second end portion b2 of the B phase coil 37 due to ON (conducting state) control of the low-side arm B phase transistor SbL, an induced voltage is generated in the A phase coil 36 such that magnetization of the core 35 is offset, the current Ia flows from the first end portion a1 to the second end portion a2 of the A phase coil 36.

At the time of electrification of the A phase coil 36 and the B phase coil 37, the A phase leakage magnetic flux ΦLa due to electrification of the A phase coil 36 and the B phase leakage magnetic flux ΦLb due to electrification of the B phase coil 37 are generated in a gap 45 in a central portion of the core 35. The direction of the A phase leakage magnetic flux ΦLa and the direction of the B phase leakage magnetic flux ΦLb are the same directions as each other.

For example, the direction of the A phase leakage magnetic flux ΦLa generated during electrification in which the current Ia flows from the first end portion a1 to the second end portion a2 of the A phase coil 36 and the direction of the B phase leakage magnetic flux ΦLb generated during electrification in which the current Ib flows from the first end portion b1 to the second end portion b2 of the B phase coil 37 are the same directions from each of the first leg portions 41a and 42a toward each of the second leg portions 41b and 42b.

The A phase magnetic flux Φa and the B phase magnetic flux Φb weaken each other inside the first split core 41 and the second split core 42. The magnitude of the A phase magnetic flux Φa and the magnitude of the B phase magnetic flux Φb differ from each other due to the leakage magnetic fluxes ΦLa and ΦLb. The difference between the magnitude of the A phase magnetic flux Φa and the magnitude of the B phase magnetic flux Φb acts as an inductor.

For example, during electrification in which the current Ia flows from the first end portion a1 to the second end portion a2 of the A phase coil 36 and the current Ib flows from the first end portion b1 to the second end portion b2 of the B phase coil 37, boosting operation is performed by accumulating and discharging magnetic energy with respect to the inductor using a change in the difference between the magnitude of the A phase magnetic flux Φa and the magnitude of the B phase magnetic flux Φb.

The core 35 is constituted of the first split core 41 and the second split core 42, but the embodiment is not limited thereto. For example, the core 35 may be constituted of split cores having different shapes other than U-shapes or may be constituted of a single member having a suitable shape.

In the embodiment described above, the drive unit 1 and the electric power control apparatus 10 are mounted in a vehicle, but the embodiment is not limited thereto. They may be mounted in a different instrument.

The embodiment of the present invention has been presented as an example and is not intended to limit the scope of the invention. The embodiment thereof can be performed in various other forms and can be subjected to various omissions, replacements, and changes within a range not departing from the gist of the invention. The embodiment and the modification thereof are included in the invention disclosed in the claims and a range equivalent thereto as they are included the scope and the gist of the invention.

What is claimed is:

1. An electric power control apparatus comprising:
a controller that controls transfer of electric power between a motor and a power storage device; and
a case that accommodates the controller,
wherein the controller comprises a magnetically coupled reactor, and
wherein at least part of the case around the reactor comprises a non-conductive wall portion formed of a non-conductive material.

2. The electric power control apparatus according to claim 1 further comprising:
a cooler that cools the reactor,
wherein a surface of the case around the reactor overlapping the cooler in a plan view is formed of a non-conductive material.

3. The electric power control apparatus according to claim 1,
wherein a side surface of the case around the reactor is formed of a non-conductive material.

4. The electric power control apparatus according to claim 1,
wherein a lower part of the case is formed of a non-conductive material.

5. A drive unit comprising:
the electric power control apparatus according to claim 1; and
a second case that accommodates the motor and is connected to the case,
wherein the non-conductive wall portion is provided in part of the case on the second case side.

6. The drive unit according to claim 5,
wherein the second case is disposed away from the non-conductive wall portion by a predetermined interval.
